(19) United States
(12) Patent Application Publication
(10) Pub. No.: US 2026/0186393 A1
(43) Pub. Date: Jul. 2, 2026

(54) SWIMMING POOL ENTERTAINMENT DEVICE

(71) Applicant: SAS POOL-ON, La Ciotat (FR)

(72) Inventor: Matthieu COMBAT, Ceyreste (FR)

(73) Assignee: SAS POOL-ON, La Ciotat (FR)

(21) Appl. No.: 19/127,594

(22) PCT Filed: Nov. 13, 2023
(86) PCT No.: PCT/EP2023/081601

§ 371 Date: May 6, 2025

(30) Foreign Application Priority Data
Nov. 14, 2022 (FR) 2211832

(51) Int. Cl. G03B 21/14; E04H 4/14; G03B 21/16

(52) U.S. Cl. CPC G03B 21/145; E04H 4/14; G03B 21/16

(57) ABSTRACT

An entertainment device for a swimming pool comprises a housing that accommodates a video projector capable of casting at least one image onto a bottom of the swimming pool. The housing is provided with a circuit for cooling the video projector and/or electrical and/or electronic components accommodated inside the housing. The entertainment device comprises a fastening device comprising at least two fastening links.

The invention relates to a swimming pool entertainment device. Its purpose is to provide such a device. It also relates to an entertainment system comprising a plurality of devices equipping a single swimming pool. It also relates to an entertainment installation comprising a plurality of entertainment systems equipping a plurality of swimming pools.

Swimming in a pool is a sport or leisure activity practiced by many people. Such a practice often involves a series of pool crossings over a length of the pool. This multiplicity of crossings is often deemed tedious or boring by swimmers, who may be tempted to abandon the activity for another sport. Additionally, such a practice is fundamentally solitary, which often makes it frustrating.

Moreover, the operating and maintenance costs inherent in running swimming pools are increasingly onerous for the operator. It is therefore advisable for the operator to offer new activities and/or entertainment that are likely to win the loyalty of existing customers, or attract new customers, or even for one-off events, as such attractiveness makes the operation more profitable. It is also desirable for the operator to offer new activities with the lowest possible investment in equipment and supervisory staff. This desire is all the more crucial given that swimming has changed little in recent decades, compared to other sports and leisure activities.

Document WO2013/121229 describes an underwater image projection system that is immersed in a pool and projects these images onto one of the surfaces delimiting the pool. The projection system comprises an enclosure equipped with a lens. The projection system also comprises a projection element with a light source that projects and directs the image. A controller, coupled to the light source, controls the light source and a steering device for the projected light source. An entertainment operator supplies image data to the controller via an input device. The controller interprets the supplied image data into a set of image control variables and controls the light source, so that the projection element projects a static or moving image onto one of the pool surfaces.

Such a system has the disadvantage of being unattractive, offering no interactivity between swimmers and/or pool spectators, and providing entertainment of low quality and diversity.

Another disadvantage of such a system is that its durability is low.

Another disadvantage of such a system is that installation on a swimming pool is time-consuming and tedious.

One of the aims of the present invention is to offer a robust, long-lasting entertainment device that allows better use of the swimming pool, based on a simple, effective and inexpensive entertainment device, the entertainment device being motivating and recreational for a swimming user.

Another aim of the present invention is to provide an entertainment device that can be easily and quickly installed on or removed from the pool without damaging the pool structure, so that temporary entertainment is possible inside the pool.

Another aim of the present invention is to provide an entertainment device that allows images to be projected onto a lane without any length limit.

Another aim of the present invention is to provide an entertainment device that offers an audio ambiance.

Another aim of the present invention is to provide an entertainment device with a simple control system.

Finally, another aim of the present invention is to make swimming in a pool, or other aquatic activities such as synchronized swimming, water polo or the like, as attractive as possible, in particular by making swimming instruction more accessible, for all public or individual pools, all audiences, whatever the age and/or sporting level of the users.

These aims are achieved by proposing an entertainment device for a swimming pool, the device comprising a housing that accommodates a video projector capable of casting at least one image onto a bottom of the swimming pool. The housing is provided with a circuit for cooling the video projector and/or electrical and/or electronic components accommodated inside the housing.

According to the present invention, the entertainment device comprises a fastening device comprising at least two fastening links.

The entertainment device advantageously comprises any one or more of the following technical features, taken alone or in combination:
the fastening device comprises a fastening member connected to the fastening links and designed to be accommodated inside a recess,
the fastening member is telescopic,
the fastening member comprises a body equipped with at least one threaded rod movable within a channel formed through the body,
the body is shaped like a ring comprising two straight branches that are parallel to one another,
the body comprises at least one shaft interposed between the branches, the shaft housing a channel inside which the threaded rod is movable,
the cooling circuit comprises at least one thermally conductive part which is interposed between the video projector and/or the electrical and/or electronic components and the housing,
the electrical and/or electronic components comprise remote communication means for exchanging data with an external receiver/transmitter in connection with equipment fitted to a swimmer and/or the swimming pool and/or lines of floaters fitted to the swimming pool,
the housing is watertight,
the housing houses watertight compartments.

The present invention also relates to an entertainment system comprising a plurality of such entertainment devices.

The present invention also relates to an entertainment installation comprising a plurality of such entertainment systems which equip a plurality of swimming pools.

The present invention and its advantages will be better understood on reading the following description and non-limiting embodiments, with reference to the appended figures, wherein:

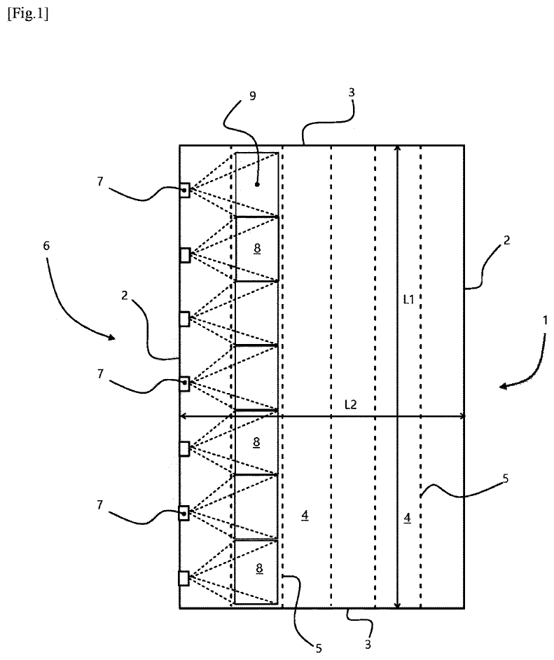

FIG. 1 shows a top view of a swimming pool equipped with an entertainment system of the present invention comprising a plurality of entertainment devices according to the present invention.

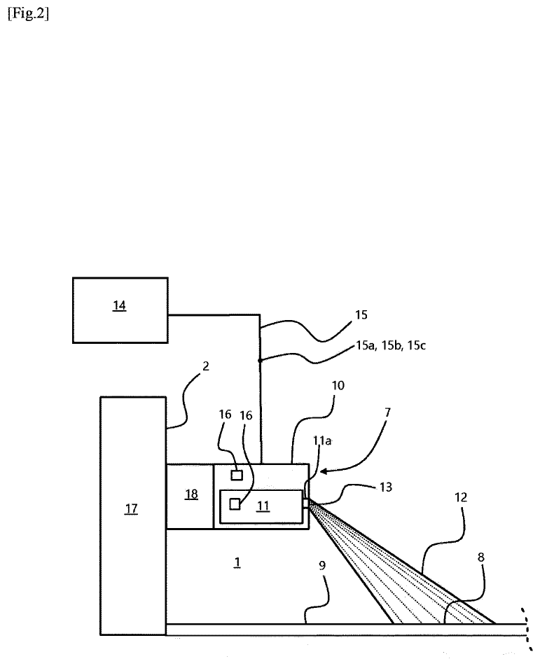

FIG. 2 shows a schematic side view of one of the entertainment devices shown in FIG. 1.

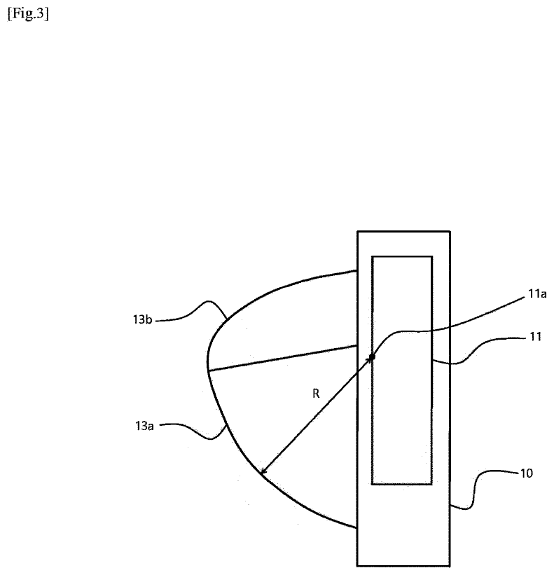

FIG. 3 shows a schematic side view of a component housing of the entertainment device shown in FIG. 2.

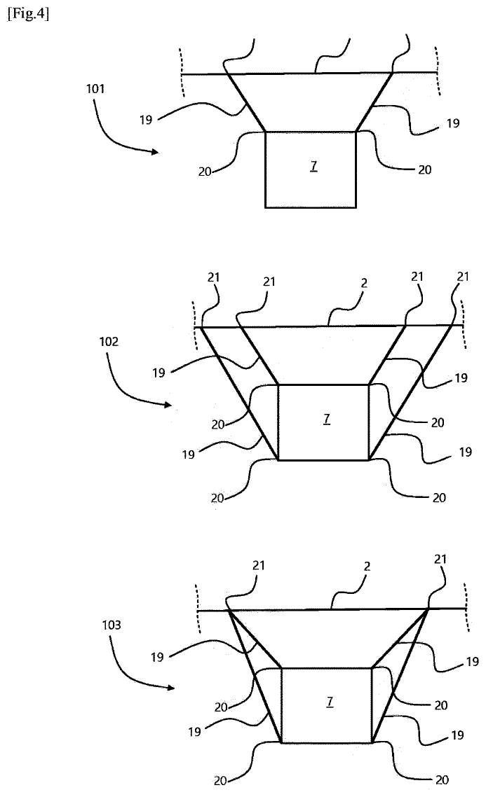

FIG. 4 shows front views of three ways of attaching the entertainment device shown in FIG. 2 to a swimming pool.

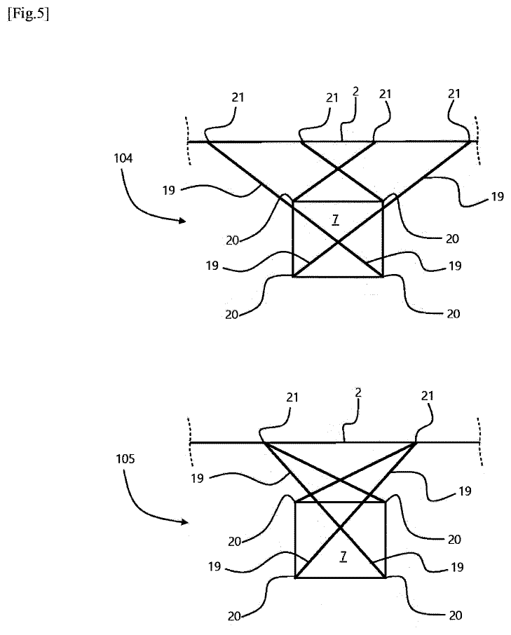

FIG. 5 shows front views of two other ways of attaching the entertainment device shown in FIG. 2 to a swimming pool.

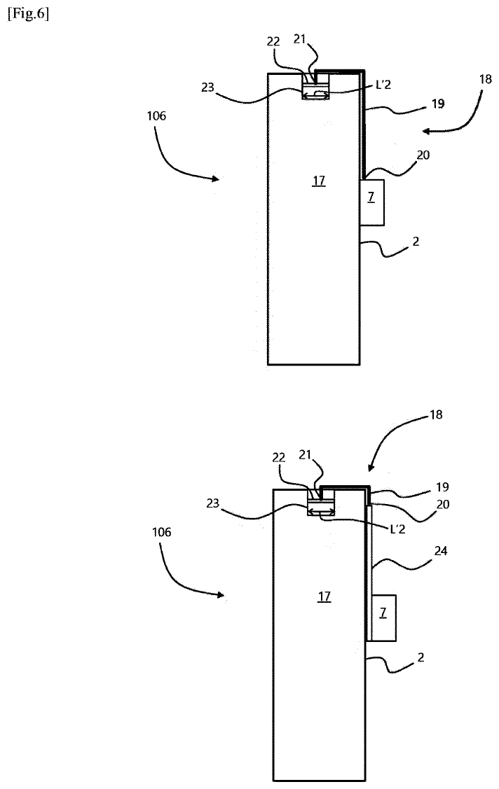

FIG. 6 shows side views of two other ways of attaching the entertainment device shown in FIG. 2 to a swimming pool.

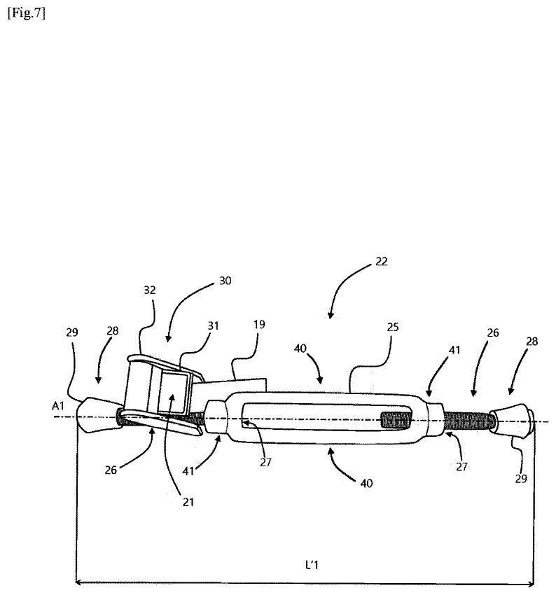

FIG. 7 shows a fastener participating in the entertainment device shown in the previous figures.

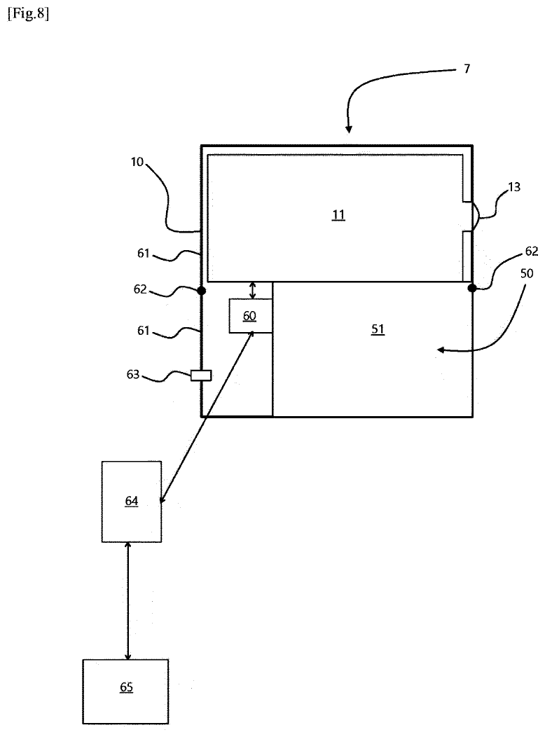

FIG. 8 shows a cooling circuit for the entertainment device shown in FIGS. 1 to 6.

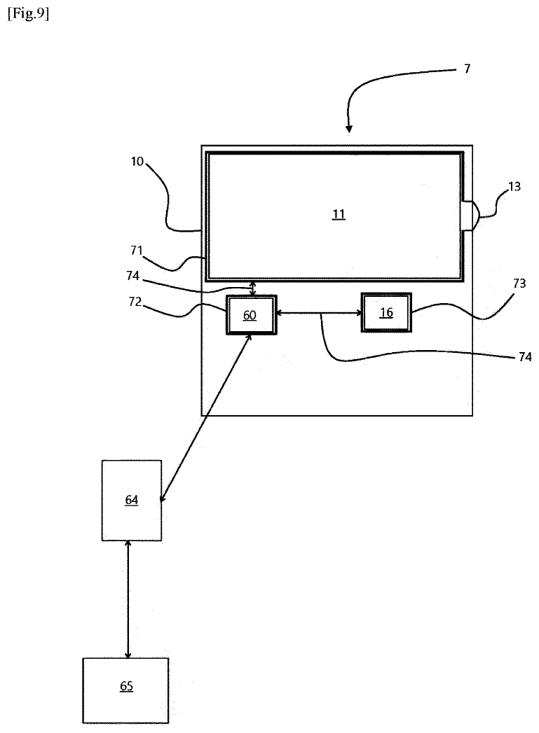

FIG. 9 shows a variant embodiment of the entertainment device shown in FIGS. 1 to 6.

FIG. 1 shows a swimming pool 1 as seen from above. The swimming pool 1 can be either a pool forming part of a nautical center intended for public use, or a private pool. The swimming pool 1 has a parallelepiped shape, preferentially rectangular, and is delimited by two longitudinal edges 2 of a first length L1 and two lateral edges 3 of a first width L2. The swimming pool 1 comprises a plurality of lanes 4 running parallel to one another and along the first length L1 of the swimming pool 1. Two contiguous lanes 4 are separated from one another by a line of floaters 5. Each lane 4 forms a training and/or competition lane for a swimmer.

According to the present invention, the swimming pool 1 is equipped with an entertainment system 6 comprising a plurality of entertainment devices 7 which are distributed along the first length L1 of the swimming pool 1. In particular, the entertainment devices 7 are equally spaced along one of the longitudinal edges 2 or both longitudinal edges 2. Each entertainment device 7 is able to project an image 8 onto a bottom 9 of the swimming pool 1, for example over a strip 5 meters long and 2.5 meters wide, to within plus or minus 10%, and over the entire first length L1 of the swimming pool 1. In other words, the entertainment system 6 is able to project an image 8 onto the bottom 9 of the swimming pool 1 of each lane 4 and over the entire first length L1 of the latter, the images 8 being contiguous two by two to give the impression of a continuous image over the entire first length L1 of the swimming pool 1. In another embodiment, the entertainment devices 7 are arranged on the bottom 9 of the swimming pool 1, to project the images 8 onto the center of the swimming pool 1 or onto the longitudinal edges 2 and/or lateral edges 3. The entertainment devices 7 can also be grouped in pairs, particularly one above the other, to double the brightness of the images 8 or to create a three-dimensional effect of the images 8. It should be noted at this point that the images 8 can be either static or animated. Thus, when the user is swimming in his lane 4, he can watch these images 8, which are suitable for entertainment and/or information. These images 8 assigned to a lane 4 can be customized for the user of this lane 4.

In FIG. 2, each entertainment device 7 comprises a housing 10 that accommodates at least one video projector 11, such as an ultra short throw laser projector or the like, commonly referred to as a UST laser projector. The video projector 11 comprises a light source 11a capable of generating a projection cone 12 that passes through a window 13 in the housing 10 to form the image 8 on the bottom 9 of the swimming pool 1. The light source 11a can be a laser source, a light-emitting diode source or a micro-light-emitting diode source.

According to a variant shown in FIG. 3, the window 13 comprises a spherical diopter 13a having, for example, a diopter radius R of the order of 260 mm, to within +/−10%, the diopter radius R being the distance between the window 13 and the light source 11a. Note that the spherical diopter 13a is arranged around a diopter center coincident with the light source 11a. Note also that the spherical diopter 13a is made, for example, from a quarter sphere of plastic or glass. These measures are designed to correct optical distortions caused by the water inside the swimming pool 1.

The window 13 also comprises a cover 13b which overhangs the spherical diopter 13a, to protect the latter, and which is made, for example, of a less expensive, more resistant and possibly opaque plastic material.

The entertainment devices 7 of the entertainment system 6 are connected to a control unit 14 via a wired connection 15. The wired connection 15 comprises a power cable 15a, which supplies the entertainment device 7 with a maximum of 12 V DC or 30 V DC, in particular 24 V DC in compliance with low-voltage safety standards. The wired connection 15 also includes a communication cable 15b, such as a USB cable link or the like, which is suitable for transmitting data from the control unit 14 to the entertainment device 7 or from the entertainment device 7 to the control unit 14. In the latter case, the data is, for example, data relating to a temperature of the video projector 11 or of the air contained inside the housing 10. It is understood that the housing 10 houses at least one sensor 16, such as a temperature sensor able to measure the temperature of the video projector 11 or of the fluid contained inside the housing 10 and/or a humidity sensor able to measure the humidity of the air to prevent fogging inside the housing 10. Finally, the wired connection 15 comprises a video cable 15c, which is able to transmit an image stream from the control unit 14 to the entertainment device 7, and more particularly to the video projector 11, this video cable 15c possibly being an HDMI cable, an Ethernet cable, an optical fiber, a DisplayPort cable, a Thunderbolt cable, an SDI cable, a USB cable or the like.

According to one embodiment, the entertainment devices 7 are connected to the control unit 14 in series. According to another embodiment, the entertainment devices 7 are connected in parallel to the control unit 14.

Each entertainment device 7 is also attached to a wall 17 of the swimming pool, in particular a wall 17 forming one of the longitudinal edges 2, by means of a fastening device 18.

FIGS. 4 to 6 show different versions of the fastening device 18.

According to a first embodiment 101 shown in FIG. 4, the fastening device 18 comprises two fastening links 19. Each fastening link 19 connects an attachment point 20 on the entertainment device 7 to an anchoring point 21 on one of the longitudinal edges 2 of the swimming pool 1.

According to a second embodiment 102 shown in FIG. 4, the fastening device 18 comprises four fastening links 19. Each fastening link 19 connects an attachment point 20 on the entertainment device 7 to a respective anchoring point 21 on one of the longitudinal edges 2 of the swimming pool 1. The fastening links 19 are arranged substantially parallel in pairs.

According to a third embodiment 103 shown in FIG. 4, the fastening device 18 also comprises four fastening links 19. A pair of fastening links 19 are connected, on the one hand, to a single anchoring point 21 on one of the longitudinal edges 2 of the swimming pool 1 and, on the other hand, to two attachment points 20 on the entertainment device 7, the fastening links 19 not crossing one another.

According to a fourth embodiment 104 shown in FIG. 5, the fastening device 18 also comprises four fastening links 19. The fastening links 19 are connected, on the one hand, to a respective anchoring point 21 arranged on one of the longitudinal edges 2 of the swimming pool 1 and, on the other hand, to a respective attachment point 20 on the entertainment device 7, the fastening links 19 crossing one another in pairs.

According to a fifth embodiment 105 shown in FIG. 5, the fastening device 18 still comprises four fastening links 19. A pair of fastening links 19 are connected, on the one hand, to a single anchoring point 21 on one of the longitudinal edges 2 of the swimming pool 1 and, on the other hand, to a respective attachment point 20 on the entertainment device 7, the fastening links 19 crossing one another in pairs.

According to a sixth embodiment 106 shown in FIG. 6, the fastening device 18 comprises at least two fastening links 19 such as those described above which connect two attachment points 20 provided on the entertainment device 7 to an anchoring point 21 which is provided on a fastening member 22 housed inside an overflow recess 23 of the swimming pool 1 which is provided inside the wall 19.

According to a seventh embodiment 106 shown in FIG. 6, the fastening device 18 comprises at least two fastening links 19 such as those described above which connect two attachment points 20 provided on a wall base 24, to which the entertainment device 7 is fastened, to an anchoring point 21 which is provided on the fastening member 22 housed inside the overflow recess 23 of the swimming pool 1 which is provided inside the wall 19.

It is understood that it is possible, where technically feasible, to combine or cumulate the above-described embodiments.

FIG. 7 shows the fastening member 22 from the side. Advantageously, the fastening member 22 is telescopic. For this purpose, the fastening member 22 comprises a body 25 and two threaded rods 26 which run in translation inside a respective channel 27 formed through the body 25. It is understood that the walls delimiting the channels 27 are provided with threads complementary to those on the threaded rods 26. Preferably, the channels 27 are cylindrical and arranged around the same axis of revolution A1. Each threaded rod 26 has a distal end 28 which is fitted with a pad 29. Each pad 29 is made of an elastic material, such as rubber or the like in particular, and is designed to come into contact with the walls delimiting the recess 23. It is understood that a second length L′1 of the fastening member 22 is adjustable from the movements of the threaded rods 26 inside the channels 27 to adapt to a second width L′2 of the recess 23, and thus hold the fastening member 22 inside the recess 23. It is understood that the second width L′2 is taken between the ends of the pads 29 parallel to the axis of revolution A1. In other words, the aim is to adapt the fastening member 22 to the dimensions of the overflow recess 23 of the swimming pool 1. Such installation of the fastening member 22 inside the recess 23, and removal of the fastening member 22 from the recess 23, is quick and easy.

The fastening member 22 is also provided with a retaining device 30 for at least two fastening links 19. The retaining device 30 comprises a tongue 31 mounted movably on a bracket 32 so that it can be tilted to lock the fastening links 19 to the anchoring point 21. This makes it quick and easy to attach the entertainment device 7 to a swimming pool 1, either permanently or temporarily.

Note that the body 25 is shaped like a ring comprising two branches 40 which are parallel to one another and to the axis of revolution A1. The ends of the branches 40 are connected in pairs by two shafts 41, each shaft 41 housing a channel 27. These provisions are designed to facilitate gripping of the body 25 and fitting of the fastening member 22.

In FIG. 8, the housing 10 is provided with a circuit 50 for cooling the video projector 11 and/or electrical and/or electronic components 60 accommodated inside the housing 10. This cooling circuit 50 comprises at least one thermally conductive part 51 which is in contact with the video projector 11 and the electrical and/or electronic components 60 to transfer the heat emitted by the latter to the housing 10, which diffuses this transferred heat to the water contained in the swimming pool 1. The part 51 forms a thermal bridge between the video projector 11 and/or the electrical and/or electronic components 60 on the one hand, and the housing 10 on the other. Such a part 51 is, for example, T-shaped, with a head in contact with the video projector 11 and/or the electrical and/or electronic components 60, and a foot in contact with the housing 10.

These provisions ensure the durability of the entertainment device 7 by preventing overheating of the video projector 11 and/or the electrical and electronic components 60 accommodated inside the housing 10. Such heating is also minimized by making the watertight housing 10 of stainless steel or the like, so that the housing 10 is able to transfer heat by conduction to the water in the swimming pool 1.

In this variant, the housing 10 is a sealed housing comprising at least two shells 61 joined together, with a seal 62, for example made of an elastomer material such as EPDM, interposed between the shells 61.

It should also be noted that the housing 10 is provided with a valve 63 by means of which it is possible to create a certain vacuum inside the housing 10 to check the tightness of the entertainment device 7 prior to installation thereof in the swimming pool 1.

In FIG. 9, the housing 10 comprises watertight compartments 71, 72, 73, including a first watertight compartment 71 accommodating the video projector 11, a second watertight compartment 72 accommodating the electrical and/or electronic components 60 and a third watertight compartment 73 accommodating the sensor 16, which are interconnected by watertight connectors 74.

The electrical and/or electronic components 60 accommodated inside the housing 10 are likely to comprise remote communication means of the radio frequency, WiFi, Bluetooth or similar type for exchanging data with an external receiver/transmitter 64, such as a digital tablet, computer or the like.

In this way, data can be exchanged between equipment 65 fitted to the swimmer, such as bone conduction headphones remotely linked to the external receiver/transmitter 64, for example to synchronize an audio ambiance and the projected images 8.

Thus, it is also possible to exchange data between equipment 65 fitted to the swimmer and/or the lines of floaters 5, such as position and/or speed sensors remotely linked to the external receiver/transmitter 64, for example to synchronize the projected images 8 and the swimmer's performance. Thus, it is possible to inform the swimmer of his live performance by overlaying his performance in the images 8 and/or instructions or information issued by the swimmer's coach.

Thus, it is also possible to exchange data between equipment 65 with which the swimming pool 1 is equipped, such as cameras remotely linked to the external receiver/transmitter 64, for example to project images 8 comprising images of the swimmer himself, thus providing the latter with a mirror effect.

It is understood that these data can also be cast live by television transmission means, and that these data can also be exported and stored on a personal space dedicated to each of the swimmer users.

It is also remarkable that an entertainment installation comprising a plurality of entertainment systems equipping a plurality of swimming pools enables, for example, competitions to be held between swimming users present in swimming pools distributed throughout the world.

1. A swimming pool entertainment device, comprising a housing that accommodates a video projector capable of casting at least one image onto a bottom of the swimming pool, the housing being provided with a circuit for cooling at least one of the video projector, an electrical component, and an electronic component accommodated inside the housing, characterized in that the entertainment device comprises a fastening device having at least two fastening links.

2. The entertainment device according to claim 1, characterized in that the fastening device comprises a fastening member connected to the fastening links and designed to be accommodated inside a recess.

3. The entertainment device according to claim 2, characterized in that the fastening member is a telescopic member.

4. The entertainment device according to claim 3, characterized in that the fastening member comprises a body equipped with at least one threaded rod movable within a channel formed through the body.

5. The entertainment device according to claim 4, characterized in that the body is shaped like a ring comprising two rectilinear branches which are parallel to one another.

6. The entertainment device according to claim 5, characterized in that the body comprises at least one shaft interposed between the branches, the at least one shaft housing a channel inside which the at least one threaded rod is movable.

7. The entertainment device according to claim 1, characterized in that the cooling circuit comprises at least one thermally conductive part which is interposed between the at least one of the video projector, the electrical component, and the electronic and the housing.

8. The entertainment device according to claim 1, characterized in that the electrical component or the electronic component comprises remote communication means for exchanging data with an external receiver or transmitter in connection with equipment fitted to a swimmer, the swimming pool, or lines of floaters fitted to the swimming pool.

9. The entertainment device according to claim 1, characterized in that the housing is a sealed housing.

10. The entertainment device according to claim 1, characterized in that the housing accommodates sealed compartments.

11. An entertainment system comprising a plurality of entertainment devices according to claim 1, which equip a single swimming pool.

12. An entertainment installation comprising a plurality of entertainment systems according to claim 11, which equip the plurality of swimming pools.
